(19) United States
(12) Patent Application Publication
(10) Pub. No.: US 2023/0217086 A1
(43) Pub. Date: Jul. 6, 2023

(54) Providing and Using a Branching Narrative Content Service

(71) Applicant: Interwise Ltd., Airport City (IL)

(72) Inventors: Gal Beilis-Lev, Kfar Hess (IL); Samion Galkovski, Modiin (IL); Yehuda Volk, Tel-Aviv (IL)

(73) Assignee: Interwise Ltd., Airport City (IL)

(21) Appl. No.: 17/565,529

(22) Filed: Dec. 30, 2021

(51) Int. Cl. H04N 21/8541; H04N 21/239; H04N 21/262; H04N 21/845; H04N 21/431

(52) U.S. Cl. CPC H04N 21/8541; H04N 21/2393; H04N 21/262; H04N 21/8455; H04N 21/4312

(57) ABSTRACT

Providing and using a branching narrative content service can include receiving from a user device a request for branching narrative content including a first segment. A live manifest can be generated with time metadata, a first content segment identifier that identifies a first content segment of the first segment, and a second content segment identifier that identifies a second content segment of the first segment. The live manifest can be provided to the user device, the user device obtaining the first content segment and the second content segment using the content segment identifiers. The user device obtains a selection of a branch while the first segment is being played and an updated live manifest is generated with updated time metadata and a third content segment identifier. The user device obtains the third content segment using the third content segment identifier and plays the second segment at the user device.

### BACKGROUND

The phrase “branching narrative” may be used to describe content such as video and the like and to refer to an interactive storytelling approach in which the storyline of the content being viewed and/or interacted with is not predetermined. The author of branching narrative content may create the setting, characters, and situations addressed by the narrative, but the user can choose or define branches or paths to take within the storyline to create a unique story based on their interactions with the story world.

Branching narrative content may be of interest to consumers and some content provided by companies such as Netflix, Disney, YouTube, Amazon, and the like may include branching narrative features or scenes. Existing implementations of playing branching narrative content may currently require customized technologies installed and used by the underlying content player. In particular, dedicated or known players (e.g., players such as ExoPlayer or AVPlayer) may be implemented using custom software development kits (“SDKs”) that can be used to interact with the players to provide branching narrative, for example by causing the player to present options for paths/branches to viewers, to obtain the viewers selections, and to pre-fetch content for multiple branches within the branching narrative to accommodate various choices by the user. Such an approach to providing branching narrative content may consume network and storage resources for branches of the storyline that eventually are not explored or taken by the viewer/user.

### SUMMARY

The present disclosure is directed to providing and using a branching narrative content service. A user device such as a set-top box, laptop computer, smartphone, tablet computer, or the like can execute and/or host a playback application and a branching narrative content application. In some implantations, the branching narrative content application can be combined with the playback application, though this is not necessarily the case. Via execution of the playback application and/or the branching narrative content application, the user device can be configured to play content that includes and/or corresponds to an instance of branching narrative content. In particular, the user device can provide input to a service or application that is configured to manage the delivery of the content such as the branching narrative content service, which can be executed and/or hosted by a server computer. Upon receiving the request for the content, the branching narrative content service can identify the first segment to be included in the content and create and/or prepare a live manifest file (also referred to as a LIVE manifest file, and hereinafter also referred to as simply a “live manifest”). As is generally understood, a live manifest can be different from a video on demand (“VOD”) manifest file in that the live manifest can be updated during presentation of the content associated with the live manifest.

The live manifest can include content segment identifiers that can identify or reference content segments associated with the segment such as one or more uniform resource locators (“URLs”), uniform resource indicators (“URIs”), storage locations, network addresses, or the like. The live manifest further can include timed metadata signals (hereinafter collectively and/or generically referred to as “time metadata”) that can identify when branching narrative choices are to be presented to and/or decided upon by users; overlay data that can define text, images, and/or other aspects of the overlays that are to be presented to obtain the user's branching narrative choices; and/or other data such as advertising slot information, narrative information, and/or other information. The live manifest can include only the first segment of the content when first provided to the user device, and therefore can omit any references (e.g., content segment identifiers) to segments that potentially will be added to the content after a user makes a branch choice, but have not yet been indicated as being associated with branches chosen by the user.

The server computer can provide and/or update the live manifest to the user device and the user device can use the content segment identifiers to obtain the content segments that correspond to the first segment of the content. In some embodiments, some, all, or none of the segments of the content can be obtained from a content database or content server (“content database”), which can be operated on and/or as a part of a cloud data network (“CDN”) in some embodiments. It should be understood that this example embodiment is illustrative, and therefore should not be construed as being limiting in any way.

The content can be obtained by the user device and the live manifest can be used by the user device to arrange the content segments and present the content. Additionally, the user device can use the live manifest to identify times (e.g., via SCTE-35 indicators or other types of signals that can be included as time metadata in the live manifest) in the content at which an overlay is to be presented to a user to determine a next branch or path in the branched narrative content such as the content. The overlay can be presented at the determined time, and a selection of a next branch can be obtained from the user.

The user device can again provide the input to the server computer with the input indicating the selected branch. The branching narrative content service can be configured to determine content segments associated with the selected branch and to update the live manifest to include content segment identifiers associated with the selected branch. In some embodiments, the content segment identifiers are appended to the previous version of the live manifest so that the live manifest includes content segment identifiers for all previous and current content segments in the content (future segments that have not yet been defined or selected, of course, are not included in the live manifest yet).

In some other embodiments, the live manifest is updated to include a sliding window of time corresponding to the content, whereby content segment identifiers for completed content segments can be removed from the beginning of the live manifest and new content segment identifiers for content segments occurring in the sliding time window can be added or appended to the live manifest. In some embodiments where completed content segments can be removed from the live manifest, it should be noted that in-progress content segments may not be removed from the live manifest. At various times during playing and/or otherwise providing the content, the live manifest can be updated to ensure that the sliding window includes content segment identifiers for all content segments to be played during the sliding time window represented by the live manifest. It should be understood that this example is illustrative, and therefore should not be construed as being limiting in any way.

The updated live manifest can be provided to the user device before the first or current segment ends, and the user device can access and download the content segments identified in the live manifest (e.g., by the content segment identifiers) prior to their being needed to continue the seamless viewing of the content. The user device then can seamlessly present the new content segments of the content at the proper time, thereby avoiding perceivable delay between segments and enhancing the user experience. As the content is played and branches selected, the user device can provide the selections to the server computer, the server computer can update the live manifest and provide the updated live manifest to the user device, and the user device can again fetch the segment contents and play the content seamlessly.

While any standards can be used for the time metadata, some preferred embodiments of the concepts and technologies disclosed herein use the SCET-35 standard based on the realization that many modern playback devices recognize and use this standard for inserting advertisements and the like. As such, the branching narrative content service can be used to enhance the performance of playback for branching narrative content for any players and/or across platforms by adopting and using a standard that is widespread and supported by many playback devices or players. Also, because many playback devices or players support live content, there may be no additional implementation required to support live streaming in accordance with embodiments of the concepts and technologies disclosed herein. It should be understood that this example is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include receiving a request for branching narrative content, the branching narrative content including a first segment. The request for the branching narrative content can be received from a user device. The operations further can include generating a live manifest that includes time metadata, a first content segment identifier that identifies a first content segment of the first segment, and a second content segment identifier that identifies a second content segment of the first segment; and providing the live manifest to the user device. The user device can obtain the first content segment using the first content segment identifier and the second content segment using the second content segment identifier. The user device also can obtain a selection of a branch while the first segment is being played by the user device. The operations further can include receiving, from the user device, the selection of the branch; generating an updated live manifest that includes updated time metadata and a third content segment identifier that identifies a third content segment of a second segment that corresponds to the branch; and providing the updated live manifest to the user device. The user device can obtain the third content segment using the third content segment identifier, and can play the second segment at the user device.

In some embodiments the first segment can be played by the user device without prefetching the second segment, and the second segment can be obtained and can be played by the user device after the selection of the branch is obtained. In some embodiments the live manifest can represent the branching narrative content over a sliding window of time associated with the branching narrative content, the sliding window of time corresponding to a fixed time duration of the branching narrative content. In some embodiments the updated live manifest can include the first content segment identifier, the second content segment identifier, and the third content segment identifier. In some embodiments the updated live manifest can include the second content segment identifier and the third content segment identifier, and the updated live manifest does not include the first content segment identifier. In some embodiments the live manifest further can include overlay data that can define content of an overlay to be presented to obtain the selection of the branch. The overlay can be presented at a particular time before an end of the first segment, and the particular time can be identified in the time metadata. In some embodiments the user device can obtain the first segment and the second segment from a content database that can operate on a cloud data network.

According to another aspect of the concepts and technologies disclosed herein, a method is disclosed. The method can include receiving a request for branching narrative content, the branching narrative content including a first segment. The request for the branching narrative content can be received from a user device. The operations further can include generating a live manifest that includes time metadata, a first content segment identifier that identifies a first content segment of the first segment, and a second content segment identifier that identifies a second content segment of the first segment; and providing the live manifest to the user device. The user device can obtain the first content segment using the first content segment identifier and the second content segment using the second content segment identifier. The user device also can obtain a selection of a branch while the first segment is being played by the user device. The operations further can include receiving, from the user device, the selection of the branch; generating an updated live manifest that includes updated time metadata and a third content segment identifier that identifies a third content segment of a second segment that corresponds to the branch; and providing the updated live manifest to the user device. The user device can obtain the third content segment using the third content segment identifier, and can play the second segment at the user device.

In some embodiments the first segment can be played by the user device without prefetching the second segment, and the second segment can be obtained and can be played by the user device after the selection of the branch is obtained. In some embodiments the live manifest can represent the branching narrative content over a sliding window of time associated with the branching narrative content, the sliding window of time corresponding to a fixed time duration of the branching narrative content. In some embodiments the updated live manifest can include the first content segment identifier, the second content segment identifier, and the third content segment identifier. In some embodiments the updated live manifest can include the second content segment identifier and the third content segment identifier, and the updated live manifest does not include the first content segment identifier. In some embodiments the live manifest further can include overlay data that can define content of an overlay to be presented to obtain the selection of the branch. The overlay can be presented at a particular time before an end of the first segment, and the particular time can be identified in the time metadata. In some embodiments the user device can obtain the first segment and the second segment from a content database that can operate on a cloud data network.

According to yet another aspect of the concepts and technologies disclosed herein, a computer storage medium is disclosed. The computer storage medium can store computer-executable instructions that, when executed by a processor, cause the processor to perform operations. The operations can include receiving a request for branching narrative content, the branching narrative content including a first segment. The request for the branching narrative content can be received from a user device. The operations further can include generating a live manifest that includes time metadata, a first content segment identifier that identifies a first content segment of the first segment, and a second content segment identifier that identifies a second content segment of the first segment; and providing the live manifest to the user device. The user device can obtain the first content segment using the first content segment identifier and the second content segment using the second content segment identifier. The user device also can obtain a selection of a branch while the first segment is being played by the user device. The operations further can include receiving, from the user device, the selection of the branch; generating an updated live manifest that includes updated time metadata and a third content segment identifier that identifies a third content segment of a second segment that corresponds to the branch; and providing the updated live manifest to the user device. The user device can obtain the third content segment using the third content segment identifier, and can play the second segment at the user device.

In some embodiments the first segment can be played by the user device without prefetching the second segment, and the second segment can be obtained and can be played by the user device after the selection of the branch is obtained. In some embodiments the live manifest can represent the branching narrative content over a sliding window of time associated with the branching narrative content, the sliding window of time corresponding to a fixed time duration of the branching narrative content. In some embodiments the updated live manifest can include the first content segment identifier, the second content segment identifier, and the third content segment identifier. In some embodiments the updated live manifest can include the second content segment identifier and the third content segment identifier, and the updated live manifest does not include the first content segment identifier. In some embodiments the live manifest further can include overlay data that can define content of an overlay to be presented to obtain the selection of the branch. The overlay can be presented at a particular time before an end of the first segment, and the particular time can be identified in the time metadata. In some embodiments the user device can obtain the first segment and the second segment from a content database that can operate on a cloud data network.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIGS. 2A-2C are line drawings schematically illustrating the updating of a live manifest file, according to an illustrative embodiment of the concepts and technologies disclosed herein.

FIG. 3 is a flow diagram showing aspects of a method for obtaining branching narrative content from a branching narrative content service, according to an illustrative embodiment of the concepts and technologies described herein.

FIG. 4 is a flow diagram showing aspects of a method for providing branching narrative content by a branching narrative content service, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide a branching narrative content service, according to some illustrative embodiments of the concepts and technologies described herein.

FIG. 7 is a block diagram illustrating an example mobile device configured to interact with a branching narrative content service, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to providing and using a branching narrative content service. A user device such as a set-top box, laptop computer, smartphone, tablet computer, or the like can execute and/or host a playback application and a branching narrative content application. In some implantations, the branching narrative content application can be combined with the playback application, though this is not necessarily the case. Via execution of the playback application and/or the branching narrative content application, the user device can be configured to play content that includes and/or corresponds to an instance of branching narrative content. In particular, the user device can provide input to a service or application that is configured to manage the delivery of the content such as the branching narrative content service, which can be executed and/or hosted by a server computer. Upon receiving the request for the content, the branching narrative content service can identify the first segment to be included in the content and create and/or prepare a live manifest.

The live manifest can include content segment identifiers that can identify or reference content segments associated with the segment such as one or more URLs, URIs, storage locations, network addresses, or the like. The live manifest further can include time metadata that can identify when branching narrative choices are to be presented to and/or decided upon by users; overlay data that can define text, images, and/or other aspects of the overlays that are to be presented to obtain the user's branching narrative choices; and/or other data such as advertising slot information, narrative information, and/or other information. The live manifest can include only the first segment of the content when first provided to the user device, and therefore can omit any references (e.g., content segment identifiers) to segments that potentially will be added to the content after a user makes a branch choice, but have not yet been indicated as being associated with branches chosen by the user.

The server computer can provide the live manifest to the user device and the user device can use the content segment identifiers to obtain the content segments that correspond to the first segment of the content. In some embodiments, some, all, or none of the segments of the content can be obtained from a content database or content server (“content database”), which can be operated on and/or as a part of a cloud data network in some embodiments. It should be understood that this example embodiment is illustrative, and therefore should not be construed as being limiting in any way.

The content can be obtained by the user device and the live manifest can be used by the user device to arrange the content segments and present the content. Additionally, the user device can use the live manifest to identify times (e.g., via time signals in any format such as SCTE-35 indicators or other time signals that can be included as time metadata in the live manifest) in the content at which an overlay is to be presented to a user to determine a next branch or path in the branched narrative content such as the content. The overlay can be presented at the determined time, and a selection of a next branch can be obtained from the user.

The user device can again provide the input to the server computer with the input indicating the selected branch. The branching narrative content service can be configured to determine content segments associated with the selected branch and to update the live manifest to include content segment identifiers associated with the selected branch. In some embodiments, the content segment identifiers are appended to the previous version of the live manifest so that the live manifest includes content segment identifiers for all content segments in the content.

In some other embodiments, the live manifest is updated to include a sliding window of time corresponding to the content, whereby content segment identifiers for completed content segments can be removed from the live manifest and new content segment identifiers for content segments occurring in the sliding time window can be added to the live manifest. In some embodiments where completed content segments can be removed from the live manifest, it should be noted that in-progress content segments may not be removed from the live manifest. At various times during playing and/or otherwise providing the content, the live manifest can be updated to ensure that the sliding window includes content segment identifiers for all content segments to be played during the sliding time window represented by the live manifest. It should be understood that this example is illustrative, and therefore should not be construed as being limiting in any way.

The updated live manifest can be provided to the user device before the first or current segment ends, and the user device can access and download the content segments identified in the live manifest (e.g., by the content segment identifiers) prior to their being needed to continue the seamless viewing of the content. The user device then can seamlessly present the new content segments of the content at the proper time, thereby avoiding perceivable delay between segments and enhancing the user experience.

As the content is played and branches selected, the user device can provide the selections to the server computer, the server computer can update the live manifest and provide the updated live manifest to the user device, and the user device can again fetch the segment contents and play the content seamlessly. While any standards can be used for the time metadata, some preferred embodiments of the concepts and technologies disclosed herein use the SCET-35 standard based on the realization that many modern playback devices recognize and use this standard for inserting advertisements and the like. It should be understood, however, that other standards and/or other formats for time signals are possible and are contemplated.

In some embodiments of the concepts and technologies disclosed herein that use known standards for these time signals (e.g., the SCET-35 standard), the branching narrative content service can be used to enhance the performance of playback for branching narrative content for any players and/or across platforms by adopting and using a standard that is widespread and supported by many playback devices. It should be understood that this example is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

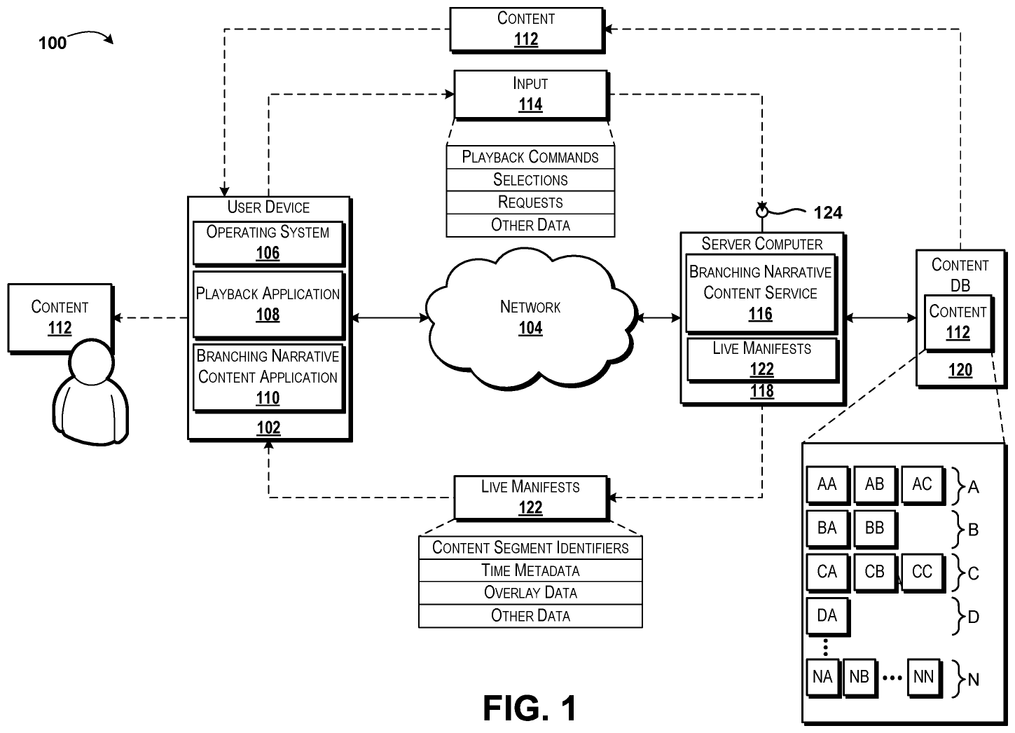

Referring now to FIG. 1, aspects of an operating environment 100 for various embodiments of the concepts and technologies disclosed herein for providing and using a branching narrative content service will be described, according to an illustrative embodiment. The operating environment 100 shown in FIG. 1 includes a user device 102. The user device 102 can operate in communication with and/or as a part of a communications network (“network”) 104, though this is not necessarily the case.

According to various embodiments, the functionality of the user device 102 may be provided by one or more video playback devices, desktop computers, mobile telephones, laptop computers, set-top boxes, other computing systems, and the like. For purposes of describing the concepts and technologies disclosed herein, the user device 102 is described herein as an instance of consumer premises equipment (“CPE”) such as a video playback device. It can be appreciated that a smartphone, tablet computer, and/or other computing devices can be used to view and/or interact with content as illustrated and described herein. As such, it should be understood that the described embodiment is illustrative, and should not be construed as being limiting in any way.

The user device 102 can execute an operating system 106 and one or more application programs such as, for example, a playback application 108 and a branching narrative content application 110. The operating system 106 can include a computer program that can control the operation of the user device 102. The playback application 108 and the branching narrative content application 110 can include executable programs that can be configured to execute on top of the operating system 106 to provide various functions as illustrated and described herein for obtaining, interacting with, and/or presenting branching narrative content or other content. Although the playback application 108 and the branching narrative content application 110 are illustrated as two separate applications, it should be understood that in some embodiments of the concepts and technologies disclosed herein these applications can be combined into and/or provided by a single application or module. As such, the illustrated embodiment is illustrative and should not be construed as being limiting in any way.

The playback application 108 can include an application for playing video or other media, which according to various implementations of the concepts and technologies disclosed herein can include branching narrative content (hereinafter referred to simply as “content”) 112. The content 112 and its components will be illustrated and described in additional detail hereinbelow, but it should be understood at this point that the playback application 108 can support functions typically associated with a set-top box, customer premises equipment, a video or media viewing application, and/or the like such as, for example, playing/displaying the content 112 to a user on demand or when requested; pausing the playing/displaying of the content 112; enabling and/or supporting the selection of branches when viewing/displaying branching narrative content as the content 112; and/or other functions as are generally understood. Because the playback of the content 112 is generally understood, the functionality of the playback application 108 will not be further described in detail here.

The branching narrative content application 110 can be configured to provide the functionality illustrated and described herein for enabling the display of branching narrative content such as the content 112. According to various embodiments of the concepts and technologies disclosed herein, the branching narrative content application 110 can be configured to obtain content 112 from, and provide input 114 to, a branching narrative content service 116, which can be executed and/or hosted by a server computer 118 or other computing device. According to various embodiments of the concepts and technologies disclosed herein, the content 112 that is obtained by the user device 102 can include branching narrative content that enables a user to alter the content 112 being viewed and/or displayed, as generally is understood.

The input 114 can include, for example, playback commands (e.g., commands to obtain and play the content 112, commands to pause progression of the story line associated with the content 112, other playback commands, or the like); selections (e.g., data that can indicate selection of a branch or path to be taken in a branching narrative content presentation, user input, other data, or the like); requests (e.g., requests for content 112, requests to change destinations for the content 112, or the like); and other data (e.g., data rates, loss, jitter, or other network information; device authentication information; or any other data that may be exchanged between the user device 102 and the branching narrative content service 116). Because the input 114 can include other data as illustrated and described herein, it should be understood that these examples of the input 114 are illustrative, and therefore should not be construed as being limiting in any way.

In some embodiments, the content 112 includes a branching narrative media presentation and a user can be provided with an option to choose or select, at some time (e.g., some point in the runtime) in the content 112, to select a branch or path for the branching narrative storyline to follow after the current segment completes. For example, a user may be presented with an option to choose one path chosen from Path A, Path B, or Path C. The user's selection, for example, Path C, can be provided to the branching narrative content service 116 as part of the input 114 and used as will be illustrated and described herein. It should be understood that this example is illustrative, and therefore should not be construed as being limiting in any way.

The branching narrative content application 110 can interact with the branching narrative content service 116 to provide the branching narrative program or other media as the content 112, and to do so in accordance with the concepts and technologies disclosed herein for providing the branching narrative content using the branching narrative content service 116. The illustrated and described embodiments can be configured to enable an efficient use of resources to provide the branching narrative content without having to pre-fetch all of the next-available and/or next-possible segments of the branching narrative storyline, as will be explained in more detail below.

Although the content 112 is illustrated as being provided to the user device 102 directly by a content server or content database 120 (labeled “content DB” in FIG. 1) as a file or stream, it should be understood that in some embodiments the branching narrative content service 116 can obtain the content 112 from the content database 120 and forward the content 112 to the user device 102, make available a stream of the content 112, and/or support downloading of the content 112 by the user device 102, if desired. In the illustrated embodiment, the content database 120 can correspond to a content server or other content repository that can reside on and/or operate as a part of a cloud data network (sometimes referred to herein by the acronym “CDN”), thereby enabling the branching narrative content service 116 and/or the content database 120 to operate as callable services. As such, it should be understood that the illustrated embodiment is illustrative of the concepts and technologies disclosed herein and should not be construed as being limiting in any way.

The branching narrative content service 116 can be configured to maintain a live manifest file (hereinafter also referred to as “live manifest”) 122 and to support the viewing of branching narrative content (the content 112 illustrated in FIG. 1) in a manner that relieves the user device 102 from having to pre-fetch and/or assemble all of the next-possible or next-available paths or branches of the content 112 during viewing at the user device 102. It can be appreciated that pre-fetching may only be practiced in some implementations when using a VOD manifest file (and not when using a live manifest 122 as illustrated and described herein). In particular, the live manifest 122 can be updated by the branching narrative content service 116 based on the input 114 from the user device 102 (e.g., including the selections of branches when presented in the content 112). Furthermore, the user device 102 can be enabled, by embodiments of the concepts and technologies disclosed herein, to present the content 112 with only the used paths or branches downloaded by the user device 102. It should be understood that this example is illustrative, and therefore should not be construed as being limiting in any way.

As illustrated in FIG. 1, the content 112 can include any number of storyline segments, which are illustrated in FIG. 1 as including segments A, B, C, D, . . . , and N. In the illustrated embodiment, segment A is the only predetermined segment of the content 112. Each of the remaining segments may be presented if the user or other entity selects the associated path or branch that includes those segments. Furthermore, each of the segments can include one or more segment components, which are illustrated in FIG. 1 as segment components AA, AB, and AC for segment A; segment components BA and BB for segment B; segment components CA, CB, and CC for segment C; segment component DA for segment D; and segment components NA, NB, . . . , and NN for segment N. Because each segment can include any number of segment components, it should be understood that the illustrated embodiment is illustrative and should not be construed as being limiting in any way.

A first portion of the content 112 may include segment A, which as noted above may be the only predetermined segment for the content 112. The branching narrative content service 116 can be configured to add information that identifies or references the segment components AA, AB, and AC, for example URLs, URIs, network locations, or the like, to the live manifest 122. The branching narrative content service 116 also can be configured to provide a copy of the live manifest 122 to the user device 102 for downloading and presenting the content 112 (beginning with segment A).

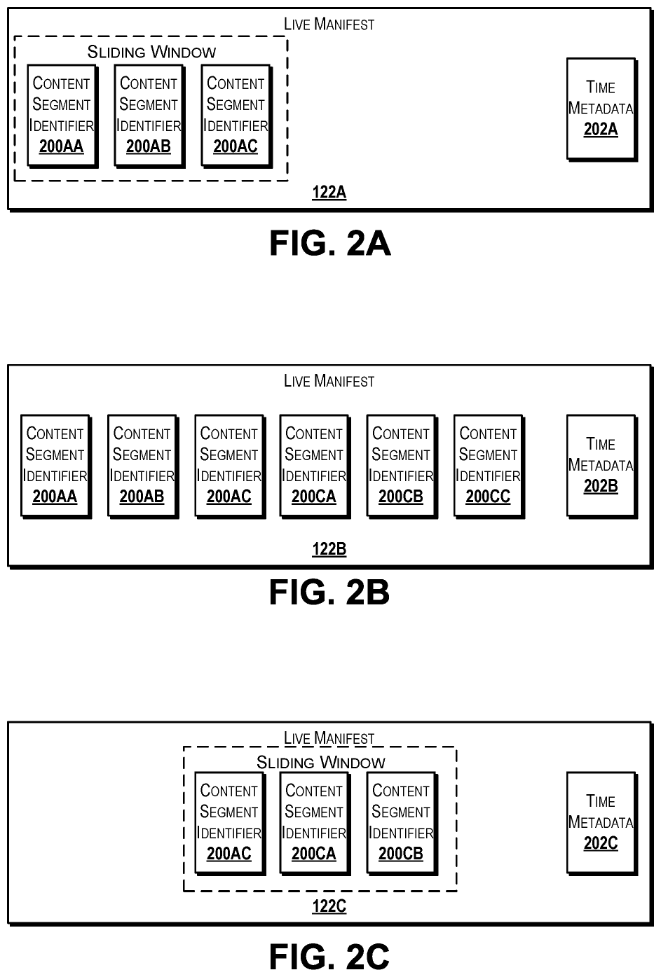

An example of the live manifest 122 is shown in FIG. 2A. Namely, FIG. 2A illustrates a first version of the live manifest 122A, which as illustrated in FIG. 2A includes a content segment identifier 200AA (which identifies the segment component AA), a content segment identifier 200AB (which identifies the segment component AB), and a content segment identifier 200AC (which identifies the segment component AC). The content segment identifiers 200AA-CC of FIGS. 2A-2C are hereinafter collectively and/or generically referred to as “content segment identifiers 200”). It can be appreciated that the first version of the live manifest 122A includes the content segment identifiers 200 that correspond to the only predetermined portions of the content 112, namely the content portions that correspond to segment A as shown in FIG. 1. The first version of the live manifest 122A also includes a first version of time metadata 202A. It should be understood that this example live manifest 122A is illustrative, and therefore should not be construed as being limiting in any way.

The first version of the time metadata 202A can indicate a play order for the content segments identified in the first version of the live manifest 122A; an insertion point for advertising or the like (if applicable); and a point at which an overlay is to be presented to the user to determine which branch of the branching narrative is to be taken and/or presented during viewing and/or presentation of the content 112. According to various embodiments of the concepts and technologies disclosed herein, the time metadata 202A can include identifiers formatted using standards such as the SCTE-35 standard, other standards, or the like; and these identifiers can specify time locations in the content 112 at which the overlays should be presented to obtain the choices of the user or other entity. In the example first version of the live manifest 122A, it can be appreciated that the time metadata 202A can indicate that the first branch choice is to be presented some time before an end of segment component AC, which is identified in the first version of the live manifest 122A by the content segment identifier 200AC. It should be understood that this example is illustrative, and therefore should not be construed as being limiting in any way.

The time or time period before the end of a segment can be determined or specified to ensure that the choice of the next branch or path is made before segment A ends, for example five seconds, ten seconds, fifteen seconds, twenty seconds, or the like. Such a time period can enable the user device 102 to obtain the choice from the user, to send the choice to the branching narrative content service 116, to receive an updated live manifest 122 that identifies the new content segments to download, to download the identified content segments, and to begin playing the next segment before or just as the first segment ends, in some embodiments. It should be understood that this example is illustrative, and therefore should not be construed as being limiting in any way.

Returning to FIG. 1, it can be appreciated that after adding the appropriate content segment identifiers 200 and time metadata 202 to the live manifest 122, the branching narrative content service 116 can provide the live manifest 122 to the user device 102 and/or otherwise make the live manifest 122 available to the user device 102 (e.g., accessible via an application programming interface (“API”) 124, a portal, or the like). As shown in the example embodiment illustrated in FIG. 1, the user device 102 can obtain the segment components AA, AB, and AC of segment A when viewing the content 112. As noted above, the user device 102 can be configured to fetch, download, access a stream, and/or otherwise obtain the segment components AA, AB, and AC directly from the content database 120 and/or from the server computer 118; and can assemble the segment components for presentation at the user device 102. It should be understood that this example is illustrative, and therefore should not be construed as being limiting in any way.

Near the end of segment A (e.g., a time period before the end as noted above), the user may be prompted to select a branch for the branching narrative storyline in the content 112. By way of example, the story branches may include segments B, C, D, or N at a particular branch, as shown in FIG. 1. At this point, the user may indicate which branch the storyline should follow, and this selection can be provided to the branching narrative content service 116 to implement (instead of the user device 102 obtaining all or portions of all possible next segments before the choice is made). The branching narrative content service 116 can be configured to update the live manifest 122 when the selection is received. For purposes of illustrating and describing the concepts and technologies disclosed herein, the description herein will assume that the user has been provided with branches B, C, D, and N and chosen to proceed along branch C. This example branch choice is used merely for convenience of description, and therefore it should be understood that this example is illustrative, and therefore should not be construed as being limiting in any way.

Turning now to FIG. 2B, the updating of the live manifest 122 based on the example choice of the user will be illustrated and described. Namely, FIG. 2B illustrates a second version of the live manifest 122B, which as illustrated in FIG. 2B includes the content segment identifiers 200 for segment A (previously added to the first version of the live manifest 122A); and also now includes the content segment identifier 200CA (which identifies the first segment component CA of segment C), a content segment identifier 200CB (which identifies the second segment component CB of segment C), and a content segment identifier 200CC (which identifies the third and last segment component CC of segment C). The second version of the live manifest 122B also includes a second version of time metadata 202B. It should be understood that this example is illustrative, and therefore should not be construed as being limiting in any way.

The second version of the time metadata 202B can indicate a play order for the content segments identified in the second version of the live manifest 122B; an insertion point for advertising or the like (if applicable); and a point at which another overlay is to be presented (if applicable) to the user to determine which branch of the branching narrative is to be taken during viewing and/or presentation of the content 112. It should be understood that this example is illustrative, and therefore should not be construed as being limiting in any way.

Turning now to FIG. 2C, another embodiment of the live manifest 122 is illustrated and will be described. In some embodiments of the concepts and technologies disclosed herein, the concept of sliding windows can be used when updating and providing the live manifest 122 illustrated and described herein. FIG. 2C can correspond to an alternative second version of the live manifest 122C, and can correspond to an update to the first version of the live manifest 122A as illustrated and described above with reference to FIG. 2A, where the user has indicated a desire to explore a branch of the branching narrative storyline that includes segment C (as illustrated and described above with reference to FIG. 2B).

When using a sliding window, however, the live manifest 122 can periodically be updated as illustrated and described herein by shifting the time window of the content 112 defined by the live manifest 122. For example, the first version of the live manifest 122A illustrated and described above with reference to FIG. 2A can correspond to a run time of the content 112 from time zero (e.g., 0:00:00.0) to some run time associated with segment A (e.g., two minutes or 0:02:00.0), as shown by the sliding time window illustrated in FIG. 2A. At some time before segment A ends, but after the user has indicated a desire to explore the branch associated with segment C, the live manifest 122 can be updated to include content segment identifiers 200 associated with part or all of segment C.

A sliding window of a certain duration can be kept updated in the live manifest 122, which in the example shown in FIG. 2C can correspond to including a reference to the last segment component of segment A (identified by the content segment identifier 200AC) and the first two segment components of segment C (identified by the content segment identifiers 200CA and 200CB). Using this approach, the live manifest 122 can be kept updated only with relevant content segment identifiers 200 still to be completed or fetched (as opposed to the second version of the live manifest 122B shown in FIG. 2B, which can include all content segments watched and/or to be fetched for future watching). Meanwhile, content segment identifiers 200 associated with content segments that have already been shown can be removed from the live manifest 122 to obtain the second version of the live manifest 122C. It should be understood that this example is illustrative, and therefore should not be construed as being limiting in any way.

Returning to FIG. 1, it can be appreciated that after adding the appropriate content segment identifiers 200 and time metadata 202 to the live manifest 122, the branching narrative content service 116 can provide the updated live manifest 122 to the user device 102 and/or otherwise make the live manifest 122 available to the user device 102. As shown in the example embodiment illustrated in FIG. 1, the user device 102 can obtain the segment components CA, CB, and CC of segment C when viewing the content 112.

As noted above, the user device 102 can be configured to fetch, download, or otherwise obtain the segment components CA, CB, and CC directly from the content database 120 and/or from the server computer 118; and can be assemble the segment components for presentation at the user device 102. Thus, it can be appreciated that the segment components CA, CB, and CC were not pre-fetched by the user device 102 until after the branch was chosen and the live manifest 122 was updated. Such an approach can reduce resource usage and/or delays in the presentation of the content 112 relative to technologies that pre-fetch all or portions of all possible paths/branches for branching narrative content being shown. It should be understood that this example is illustrative, and therefore should not be construed as being limiting in any way.

According to various embodiments of the concepts and technologies disclosed herein, the server computer 118 can expose an API 124 as noted above. In some embodiments, the API 124 can be interacted with by the user device 102 to obtain the live manifest 122 (or to access the live manifest 122 if stored exclusively at the server computer 118). In some embodiments, the API 124 also can support requests by the user device 102 for the segments identified in the live manifest 122, though this is not necessarily the case as those segments can be obtained from other sources such as the content database 120 (as is the case in the embodiment illustrated in FIG. 1). It should be understood that this example is illustrative, and therefore should not be construed as being limiting in any way.

The live manifest 122 provided to the user device 102 can include the content segment identifiers 200 at a given time in a presentation (e.g., the content segment identifiers in the live manifest 122 may be updated during presentation of the content 112 as branches are chosen and followed); time metadata 202 that identifies when overlays are to be presented to users; overlay data that defines that the overlays are to say/request; and other data. It should be understood that this example is illustrative, and therefore should not be construed as being limiting in any way.

In practice, a user device 102 such as a set-top box, laptop computer, smartphone, tablet computer, or the like can execute and/or host a playback application 108 and a branching narrative content application 110. In some implantations, the branching narrative content application 110 can be combined with the playback application 108, though this is not necessarily the case. Via execution of the playback application 108 and/or the branching narrative content application 110, the user device 102 can be configured to play content 112 that includes and/or corresponds to an instance of branching narrative content. In particular, the user device 102 can provide input to a service or application that is configured to manage the delivery of the content 112 such as the branching narrative content service 116, which can be executed and/or hosted by a server computer 118. Upon receiving the request for the content 112, the branching narrative content service 116 can identify the first segment to be included in the content 112 and create and/or prepare a live manifest 122.

The live manifest 122 can include content segment identifiers 200 that can identify or reference content segments associated with the segment such as one or more URLs, URIs, storage locations, network addresses, or the like. The live manifest 122 further can include time metadata 202 that can identify when branching narrative choices are to be presented to and/or decided upon by users; overlay data that can define text, images, and/or other aspects of the overlays that are to be presented to obtain the user's branching narrative choices; and/or other data such as advertising slot information, narrative information, and/or other information. The live manifest 122 can include only the first segment of the content 112 when first provided to the user device 102, and therefore can omit any references (e.g., content segment identifiers 200) to segments that potentially will be added to the content 112 after a user makes a branch choice, but have not yet been indicated as being associated with branches chosen by the user.

The server computer 118 can provide the live manifest 122 to the user device 102 and the user device 102 can use the content segment identifiers 200 to obtain the content segments that correspond to the first segment of the content 112. In some embodiments, some, all, or none of the segments of the content 112 can be obtained from a content database 120, which can be operated on and/or as a part of a cloud data network in some embodiments. It should be understood that this example embodiment is illustrative, and therefore should not be construed as being limiting in any way.

The content 112 can be obtained by the user device 102 and the live manifest 122 can be used by the user device 102 to arrange the content segments and present the content 112. Additionally, the user device 102 can use the live manifest 122 to identify times (e.g., via SCTE-35 indicators, other time signals formatted according to other standards, or the like, which can be included as time metadata 202 in the live manifest 122) in the content 112 at which an overlay is to be presented to a user to determine a next branch or path in the branched narrative content such as the content 112. The overlay can be presented at the determined time, and a selection of a next branch can be obtained from the user.

The user device 102 can again provide the input 114 to the server computer 118 with the input indicating the selected branch. The branching narrative content service 116 can be configured to determine content segments associated with the selected branch and to update the live manifest 122 to include content segment identifiers 200 associated with the selected branch. In some embodiments, the content segment identifiers 200 are appended to the previous version of the live manifest 122 so that the live manifest 122 includes content segment identifiers 200 for all content segments in the content 112.

In some other embodiments, the live manifest 122 is updated to include a sliding time window corresponding to the content 112, whereby content segment identifiers 200 for completed content segments can be removed from the live manifest 122 and new content segment identifiers 200 for content segments occurring in the sliding time window can be added to the live manifest 122. In some embodiments where completed content segments can be removed from the live manifest 122, it should be noted that in-progress content segments may not be removed from the live manifest 122. At various times during playing and/or otherwise providing the content 112, the live manifest 122 can be updated to ensure that the sliding window includes content segment identifiers 200 for all content segments to be played during the sliding time window represented by the live manifest 122. It should be understood that this example is illustrative, and therefore should not be construed as being limiting in any way.

The updated live manifest 122 can be provided to the user device 102 before the first or current segment ends, and the user device 102 can access and download the content segments identified in the live manifest 122 (e.g., by the content segment identifiers 200) prior to their being needed to continue the seamless viewing of the content 112. The user device 102 then can seamlessly present the new content segments of the content 112 at the proper time (e.g., when the previous segment ends), thereby avoiding perceivable delay between segments and enhancing the user experience. As the content 112 is played and branches selected, the user device 102 can provide the selections to the server computer 118, the server computer 118 can update the live manifest 122 and provide the updated live manifest 122 to the user device 102, and the user device 102 can again fetch the segment contents and play the content 112 seamlessly.

While any standards can be used for the time metadata 202, some preferred embodiments of the concepts and technologies disclosed herein use the SCET-35 standard based on the realization that many modern playback devices recognize and use this standard for inserting advertisements and the like. As such, the branching narrative content service 116 can be used to enhance the performance of playback for branching narrative content for any players and/or across platforms by adopting and using a standard that is widespread and supported by many playback devices. It should be understood that this example is illustrative, and therefore should not be construed as being limiting in any way.

FIG. 1 illustrates one user device 102, one network 104, one server computer 118, and one content database 120. It should be understood, however, that various implementations of the operating environment 100 can include one or more than one user device 102; one or more than one network 104; one or more than one server computer 118; and/or zero, one, or more than one content database 120. As such, the illustrated embodiment should be understood as being illustrative, and should not be construed as being limiting in any way.

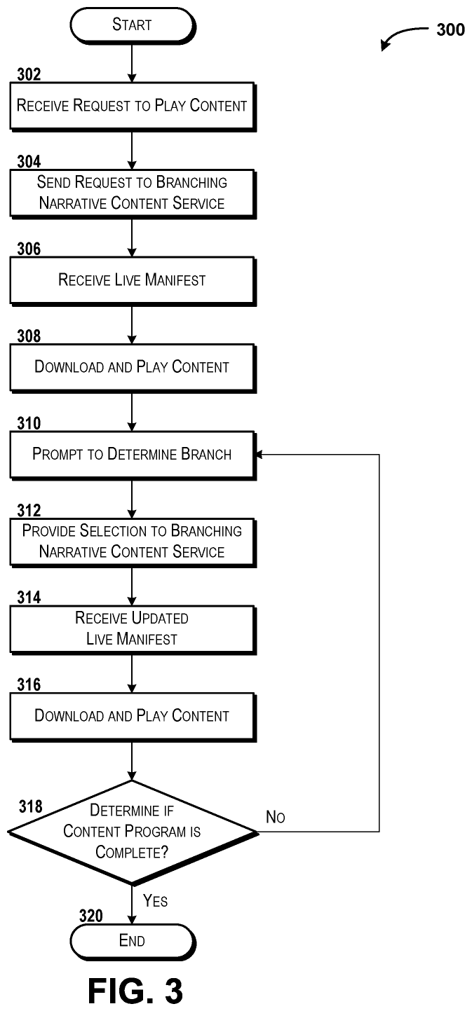

Turning now to FIG. 3, aspects of a method 300 for obtaining branching narrative content from a branching narrative content service 116 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 or the server computer 118, to perform one or more operations and/or causing the processor to direct other components of the computing system or device to perform one or more of the operations.

For purposes of illustrating and describing the concepts of the present disclosure, the method 300 is described herein as being performed by the user device 102 via execution of one or more software modules such as, for example, the playback application 108 and/or the branching narrative content application 110. It should be understood that additional and/or alternative devices and/or network nodes can provide the functionality described herein via execution of one or more modules, applications, and/or other software including, but not limited to, the playback application 108 and/or the branching narrative content application 110. Thus, the illustrated embodiments are illustrative, and should not be viewed as being limiting in any way.

The method 300 begins at operation 302. At operation 302, the user device 102 can receive a request to play content 112. For purposes of the embodiments of the concepts and technologies disclosed herein illustrated and described herein, the content 112 includes branching narrative content that includes user-chosen paths in the storylines. Thus, operation 302 can include a request to start playing the content 112 from a beginning of the program (e.g., from time zero or 0:00:00.00 or the like). In the example embodiment illustrated and described above with reference to FIGS. 1-2C, operation 302 can correspond to the user device 102 receiving a request to start playing the content 112 from the beginning, where the content 112 can start with segment referred to in the example illustrated and described herein with reference to FIG. 1 as segment A. It should be understood that this example is illustrative, and therefore should not be construed as being limiting in any way.

From operation 302, the method 300 can proceed to operation 304. At operation 304, the user device 102 can send a request to play the content 112 to the branching narrative content service 116. As noted above, the request can correspond to a request to begin playing the content 112 from the beginning. Because the content 112 can include a branching narrative program, it can be appreciated that the request can effectively correspond to a request to begin playing the first segment of the content 112. As illustrated and described above with reference to FIG. 1, the request can be provided by the user device 102 to the server computer 118 as part of the input 114, and the server computer 118 can be configured to create, update, and provide the live manifest 122 to the user device 102 to initiate presentation of the content 112. It should be understood that this example is illustrative, and therefore should not be construed as being limiting in any way.

From operation 304, the method 300 can proceed to operation 306. At operation 306, the user device 102 can receive the live manifest 122 from the server computer 118. According to various embodiments of the concepts and technologies disclosed herein, the live manifest 122 can be updated by the branching narrative content service 116 during presentation of the content 112 at the user device 102. The live manifest 122 can include references such as URLs, URIs, data storage locations, network addresses, or other embodiments of identifiers (herein referred to as content segment identifiers 200). The content segment identifiers 200 can be used by the user device 102 to fetch, download, access a stream, and/or otherwise obtain the content segments associated with the content 112. According to various embodiments of the concepts and technologies disclosed herein, the user device 102 can download the segments referenced by the content segment identifiers 200 (and not stream the content). Thus, the claims include downloading the content unless streaming is specifically mentioned in the claims. In some embodiments of the concepts and technologies disclosed herein, the user device 102 can obtain the content segments from a content database 120 that can operate on or as a part of a cloud data network. It should be understood that this example is illustrative, and therefore should not be construed as being limiting in any way.

Because the live manifest 122 can be updated periodically (e.g., at specified time intervals, upon trigger events, or the like), it can be appreciated that the user device 102 may only obtain content segments that are to be displayed by the user device 102 (i.e., embodiments of the concepts and technologies disclosed herein do not fetch content segments for segments that have not been chosen by a user or other entity at the user device 102). It should be understood that this example is illustrative, and therefore should not be construed as being limiting in any way.

From operation 306, the method 300 can proceed to operation 308. At operation 308, the user device 102 can obtain and play the content 112. In operation 308, the user device 102 can obtain and play only the those segments of the content 112 that are indicated in the live manifest 122 when received in operation 306. Thus, in the example shown in FIGS. 1-2C, the user device 102 can first download the content segments corresponding to segment A in operation 308 and begin presenting those content segments as the content 112. It should be understood that this example is illustrative, and therefore should not be construed as being limiting in any way.

From operation 308, the method 300 can proceed to operation 310. At operation 310, the user device 102 can prompt the user to determine a branch of the content 112 to be explored or played next, and to obtain a selection of which branch the user wishes to explore or play. Thus, operation 310 can correspond to the user device 102 presenting the user with a choice of at least two branches of the branching narrative story line, where the user can be prompted to select one of the at least two branches. The prompting of operation 310 is performed, and in some embodiments of the concepts and technologies disclosed herein is completed, several seconds before the current segment being shown ends (e.g., five seconds before the current segment being shown ends, ten seconds before the current segment being shown ends, fifteen seconds before the current segment being shown ends, twenty seconds before the current segment being shown ends, thirty seconds before the current segment being shown ends, or other time periods in various embodiments). This time period can be chosen and/or defined to enable the obtaining of a decision of the user with regard to which branch to take, the communication of that decision to the branching narrative content service 116, the obtaining of an updated live manifest 122, and the downloading of the content segments associated with the next branch before or as the first segment (segment A) ends. It should be understood that this example is illustrative, and therefore should not be construed as being limiting in any way.

Thus, the choice as to which branch to explore/view next can be presented and a selection can be obtained before the segment of the content 112 being shown ends; thereby preventing the user device 102 from having to pre-fetch other segments to give the user a seamless experience while avoiding a delay between the end of the current segment and a next segment. Rather, the user selects a next branch, the choice is conveyed to the branching narrative content service 116, the branching narrative content service 116 updates the live manifest 122 and provides that updated live manifest 122 to the user device 102, and the user device 102 fetches and begins playing the next (selected) segment of the content 112 in a manner that is seamless and without delay. Thus, some embodiments of the concepts and technologies disclosed herein provide branching narrative content without pre-fetching all next-possible segments and instead fetches only those segments that correspond to the user's chosen branch or path. It should be understood that this example is illustrative, and therefore should not be construed as being limiting in any way.

According to various embodiments of the concepts and technologies disclosed herein, the user device 102 can use the overlay data and time metadata 202 in the live manifest 122 to present the overlay in operation 310 with enough time to seamlessly transition to the next selected branch. Again, this time may be five seconds before the current segment being shown ends, ten seconds before the current segment being shown ends, fifteen seconds before the current segment being shown ends, thirty seconds before the current segment being shown ends, or the like, as specified by the content creator or another entity. Thus, the user device 102 can know when (in terms of the runtime of the program corresponding to the content 112) to present the overlay, and the contents of that overlay (e.g., a prompt that says “Would you like to follow path A or path B?” or the like). Thus, the user device 102 can overlay the content 112 with the prompt and wait for user input (e.g., via a remote control or other functionality), with the user input indicating a desired path for the branching narrative. It should be understood that this example is illustrative, and therefore should not be construed as being limiting in any way.

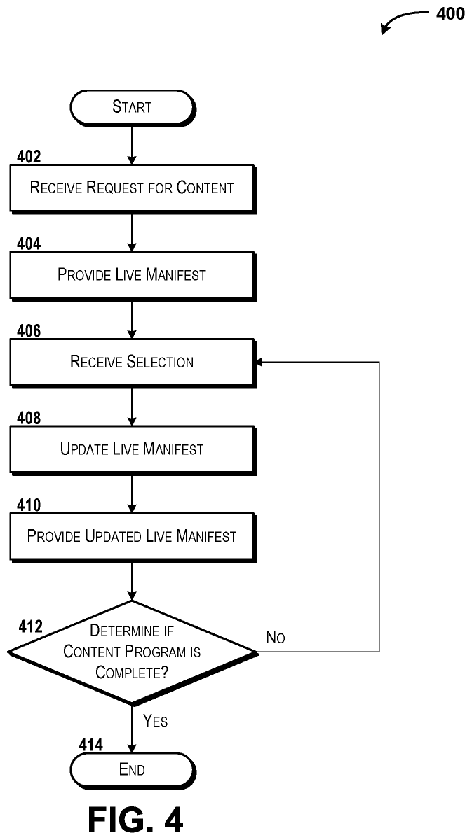

From operation 310, the method 300 can proceed to operation 312. At operation 312, the user device 102 can provide the selection to the branching narrative content service 116. As will be explained in more detail below with reference to FIG. 4, the branching narrative content service 116 can determine the next segment to view based on the selection, and update the live manifest 122 to include the content segment identifiers 200 that correspond to the segment associated with the selected branch. In some embodiments, the live manifest 122 can also be updated by the branching narrative content service 116 to remove completed content segments (e.g., the sliding window embodiment illustrated and described with reference to FIGS. 2A and 2C); while in some other embodiments the new content segment identifiers 200 can be added or appended to the live manifest 122 without removing content segment identifiers 200 for completed content segments. Because other approaches to removing and/or not removing content segment identifiers 200 are possible and are contemplated, it should be understood that these example embodiments are illustrative, and therefore should not be construed as being limiting in any way.

From operation 312, the method 300 can proceed to operation 314. At operation 314, the user device 102 can receive the updated live manifest 122. It can be appreciated from the above description that the live manifest 122 can include at least one new content segment identifier 200 and an updated version of time metadata 202. Thus, while other approaches to providing branching narrative content include the pre-fetching of all next-possible segments before the user selects a branch or path, and the use of a static manifest file, various embodiments of the concepts and technologies disclosed herein include the user device 102 only fetching content segments that have been chosen for presentation (e.g., by choosing an associated branch of the branching narrative storyline for exploration) and a dynamic manifest file (e.g., the live manifest 122) that changes over time and/or based on user selections. It should be understood that this example is illustrative, and therefore should not be construed as being limiting in any way.

From operation 314, the method 300 can proceed to operation 316. At operation 316, the user device 102 can obtain and play the content 112. Thus, in operation 316, the user device 102 can complete the previous segment currently being viewed, and then can play the content segments referenced in the new version of the live manifest 122. In various embodiments, the user device 102 can fetch the content segments referenced in the new version of the live manifest 122 before the previous segment currently being viewed ends, and can be configured to start playing those segments before or as the previous segment currently being viewed ends. Thus, operation 316 can include obtaining the segment components identified by the content segment identifiers 200 added to the live manifest 122, arranging the segment components as indicated in the live manifest 122, and outputting or displaying the content 112 at the user device 102. It should be understood that this example is illustrative, and therefore should not be construed as being limiting in any way.

From operation 316, the method 300 can proceed to operation 318. At operation 318, the user device 102 can determine if the content program is or is not complete. For example, the user device 102 can determine, in operation 318, if all of the branches and their associated segments (e.g., selection of some branches may remove other branches from being chosen, etc.) of the branching narrative program that are possible to view have been explored and/or viewed, or if all branches and their associated segments have not yet been explored and/or viewed. This information can be indicated, in some embodiments, by the time metadata 202 and/or by an indicator the program is ending, both of which optionally can be indicated in the live manifest 122 obtained in operation 314. In some other embodiments, the user device 102 can determine if the total runtime indicates completion of the content program, whether a conclusion of the content program has been reached and/or viewed, or the like. Because the determination of whether or not the content program is complete can be made in additional and/or alternative manners, it should be understood that this example is illustrative, and therefore should not be construed as being limiting in any way.

If the user device 102 determines, in operation 318, that the content program is not complete (e.g., by determining that all branches of the branching narrative program have not yet been explored and viewed, by determining that the total runtime does not indicate completion, by determining that a conclusion has not yet been reached, or otherwise determining that the content program is not yet complete), the method 300 can return to operation 310, wherein the user device 102 can again prompt the user for purposes of determining a branch to be explored. Thus, the user device 102 can again overlay the content 112 and determine which branch the user wishes to explore. Operations 310-318 of the method 300 can be iterated until the user device 102 determines, in any iteration of operation 318, that the content program is complete (e.g., by determining that all branches of the branching narrative program have been explored and viewed, by determining that the total runtime indicates completion, by determining that a conclusion has been reached, or otherwise determining that the content program is complete).

If the user device 102 determines that the content program is complete (e.g., by determining that all branches of the branching narrative program have been explored and viewed, by determining that the total runtime does indicates completion, by determining that a conclusion has been reached, or otherwise determining that the content program is complete), the method 300 can proceed to operation 320. The method 300 can end at operation 320.

Turning now to FIG. 4, aspects of a method 400 for providing branching narrative content by a branching narrative content service 116 will be described in detail, according to an illustrative embodiment. For purposes of illustrating and describing the concepts of the present disclosure, the method 400 is described herein as being performed by the server computer 118 via execution of one or more software modules such as, for example, the branching narrative content service 116. It should be understood that additional and/or alternative devices and/or network nodes can provide the functionality described herein via execution of one or more modules, applications, and/or other software including, but not limited to, the branching narrative content service 116. Thus, the illustrated embodiments are illustrative, and should not be viewed as being limiting in any way.

The method 400 begins at operation 402. At operation 402, the server computer 118 can receive a request for content 112. In various embodiments, including the embodiment illustrated in FIG. 1, the request received in operation 402 can be sent by the user device 102. It should be understood that this example is illustrative, and therefore should not be construed as being limiting in any way.

As explained above, the content 112 requested in operation 402 includes a branching narrative program or other content. Thus, the content 112 can include multiple narrative paths, with the ultimate path being user-chosen and/or user-defined. Thus, operation 402 can include receiving a request (e.g., as the input 114 provided from the user device 102) to start playing the content 112 from a beginning of the program (e.g., from time zero or 0:00:00.00 or the like). In the example embodiment illustrated and described above with reference to FIGS. 1-2C, operation 402 can correspond to the server computer 118 receiving (e.g., from the user device 102) a request to start playing the content 112 from the beginning, where the content 112 can start with segment referred to herein as segment A. It should be understood that this example is illustrative, and therefore should not be construed as being limiting in any way.

From operation 402, the method 400 can proceed to operation 404. At operation 404, the server computer 118 can provide, to the device that requested the content 112 in operation 402 (e.g., the user device 102), a live manifest 122 for the content 112 requested in operation 402. Thus, although not separately shown in FIG. 4, the server computer 118 can be configured to create the live manifest 122 as part of operation 404. The live manifest 122 can include references to one or more content segments that collectively define a first segment of the content 112. In some embodiments of the concepts and technologies disclosed herein, the live manifest includes content segment identifiers 200 for the one or more segments and time metadata 202 that defines an order of the identified content segments, a time in the segment at which an overlay is to be presented to the user or other entity to identify the next branch to explore, contents of the overlay (e.g., overlay data as illustrated and described with reference to FIG. 1) and/or other information. The server computer 118 can create the live manifest 122 and provide the live manifest 122 to the user device 102 in operation 404. It should be understood that this example is illustrative, and therefore should not be construed as being limiting in any way.

As explained above, embodiments of the concepts and technologies disclosed herein can periodically update the live manifest 122 based on one or more defined time intervals, based on trigger events (e.g., reaching an end or approaching an end of segment, determining that a choice of a branch has been made, etc.), and/or based on other considerations. Furthermore, the live manifest 122 can be updated to include content segment identifiers 200, time metadata 202, and/or other information for a sliding time window associated with the program (e.g., a one minute window, a two minute window, a five minute window, a ten minute window, and/or other time measures such as portions of minutes, hours, portions of hours, combinations thereof, or the like), in some embodiments; while in some other embodiments the live manifest 122 can be updated to include all content segment identifiers 200, time metadata 202, and/or other information for the content program that corresponds to the content 112 (including only the chosen branches) each time a branch or path is chosen or defined. These and other embodiments are included in the embodiments of the concepts and technologies disclosed herein and in the scope of the claims appended hereto unless otherwise explicitly excluded or recited.

From operation 404, the method 400 can proceed to operation 406. At operation 406, the server computer 118 can receive a selection, e.g., a selection of a branch from the user device 102. According to various embodiments of the concepts and technologies disclosed herein, the user device 102 can present an overlay with the content 112 and determine the next branch to explore or view. The selection of the next branch can be indicated in input 114 received from the user device 102. Thus, operation 406 can correspond to the server computer 118 receiving an indication of the next branch to be viewed/explored. It should be understood that this example is illustrative, and therefore should not be construed as being limiting in any way.

From operation 406, the method 400 can proceed to operation 408. At operation 408, the server computer 118 can provide an update the live manifest 122. In some embodiments, the live manifest 122 can be updated to remove content segment identifiers 200 for content segments that already have been downloaded and/or viewed at the user device 102 and updated to include or append content segment identifiers 200 for content segments associated with the next branch of the content 112 (as indicated in the selection received at operation 406). In some other embodiments, the live manifest 122 can be updated by adding or appending content segment identifiers 200 for content segments associated with the next branch of the content 112 (as indicated in the selection received at operation 406) without removing any data from the live manifest 122. Because the live manifest 122 can be updated in various manners as illustrated and described herein, it should be understood that these examples are illustrative, and therefore should not be construed as being limiting in any way.

In some embodiments of the concepts and technologies disclosed herein, the live manifest 122 can further be updated to update the time metadata 202 that defines an order of the identified content segments, a time in the segment at which another overlay is to be presented (if applicable) to the user or other entity to identify the next branch to explore, contents of the overlay (e.g., overlay data as illustrated and described with reference to FIG. 1) and/or other information. It should be understood that this example is illustrative, and therefore should not be construed as being limiting in any way.

From operation 408, the method 400 can proceed to operation 410. At operation 410, the server computer 118 can provide the updated live manifest 122 to the device that requested the content 112 in operation 402 (e.g., the user device 102). As noted above, the live manifest 122 can be periodically updated by the server computer 118 and provided to the user device 102 at various times (including time intervals, trigger events (e.g., selection of a next branch), or the like). Thus, operation 410 can include the providing of the live manifest 122 to the user device 102 at various times and therefore may occur more than once before some other operations illustrated and described with reference to FIG. 4 occur. It should be understood that this example is illustrative, and therefore should not be construed as being limiting in any way.

From operation 410, the method 400 can proceed to operation 412. At operation 412, the server computer 118 can determine if the content program is or is not complete. For example, the server computer 118 can determine, in operation 412, if all branches of the branching narrative program have been explored and viewed by the user device 102, or not. In some other example embodiments, the server computer 118 can determine if the total runtime associated with the content 112 indicates completion of the content 112. In yet other embodiments, the server computer 118 can determine if a conclusion of the content 112 has been reached. Because the server computer 118 can determine that the content program is or is not complete in additional and/or alternative manners, it should be understood that these examples are illustrative, and therefore should not be construed as being limiting in any way.

If the server computer 118 determines, in operation 412, that the content program is not complete (e.g., by determining that all branches of the branching narrative program have not yet been explored and viewed, by determining that the total runtime does not indicate completion, by determining that a conclusion has not yet been reached, or otherwise determining that the content program is not yet complete), the method 400 can return to operation 406, where the server computer 118 can wait for another user selection from the user device 102, where the user selection can indicate a branch to be explored. Operations 406-412 of the method 400 can be iterated until the server computer 118 determines, in any iteration of operation 412, that the content program is complete (e.g., by determining that all branches of the branching narrative program have been explored and viewed by the user device 102).

If the server computer 118 determines that the content program is complete (e.g., by determining that all branches of the branching narrative program have been explored and viewed, by determining that the total runtime does indicates completion, by determining that a conclusion has been reached, or otherwise determining that the content program is complete), the method 400 can proceed to operation 414. The method 400 can end at operation 414.

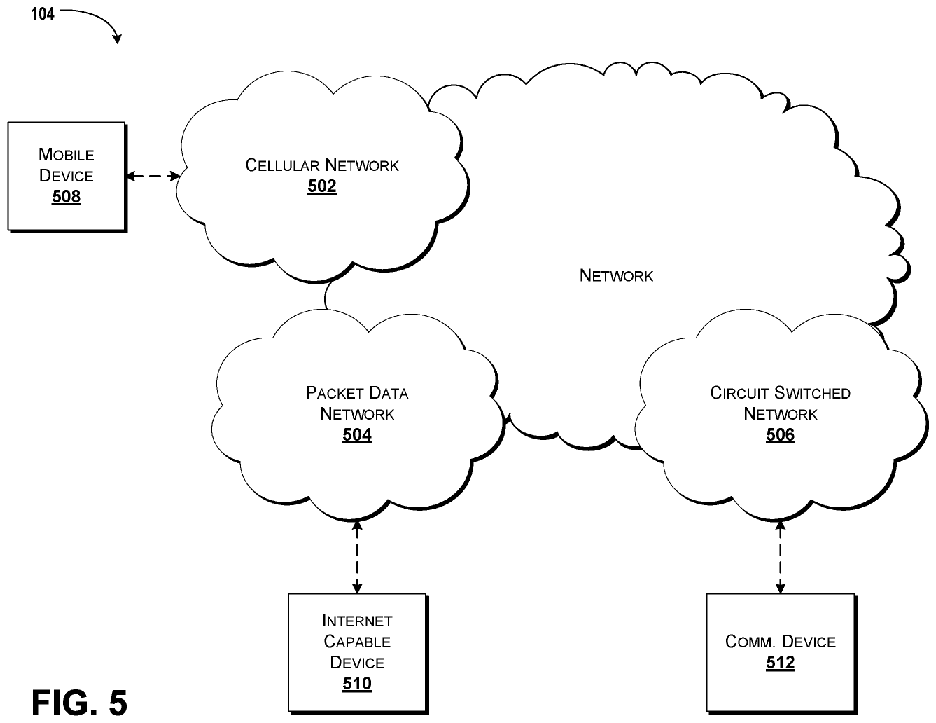

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), home subscriber servers (“HSSs”), visitor location registers (“VLRs”), charging platforms, billing platforms, voicemail platforms, GPRS core network components, location service nodes, an IP Multimedia Subsystem (“IMS”), and the like. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSDPA), and HSPA+. The cellular network 502 also is compatible with 4G mobile communications standards, 5G mobile communications standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

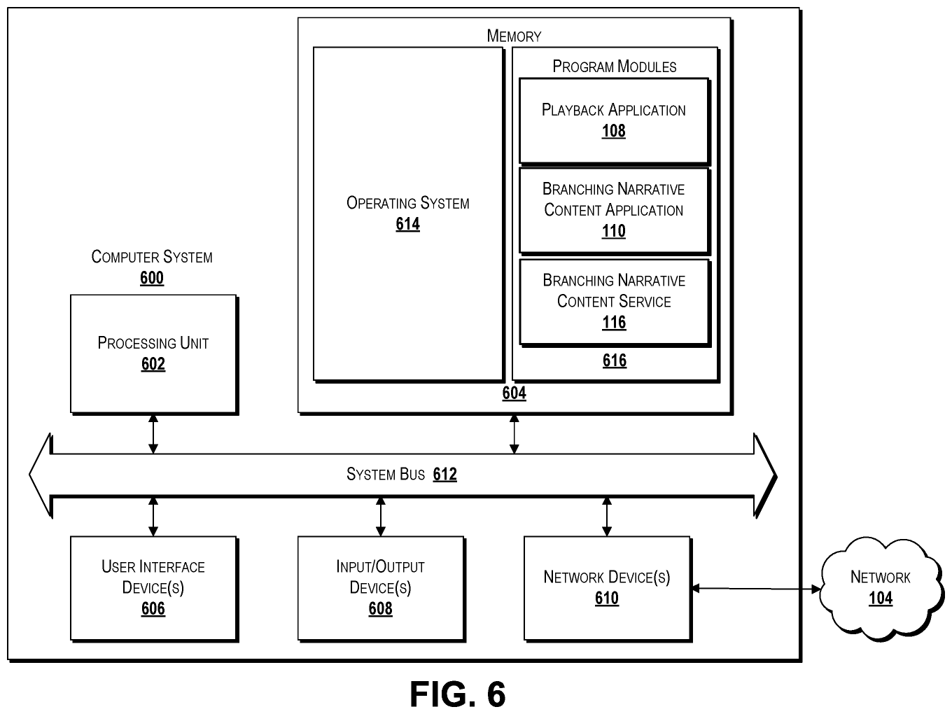

FIG. 6 is a block diagram illustrating a computer system 600 configured to provide the functionality described herein for providing and using a branching narrative content service, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the playback application 108, the branching narrative content application 110, the branching narrative content service 116, and/or other applications or services. These and/or other programs can be embodied in computer-readable media containing instructions that, when executed by the processing unit 602, perform one or more of the methods 300 and 400 described in detail above with respect to FIGS. 3-4 and/or other functionality as illustrated and described herein. It can be appreciated that, at least by virtue of the instructions embodying the methods 300 and 400 and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the content 112, the input 114, the live manifest 122, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

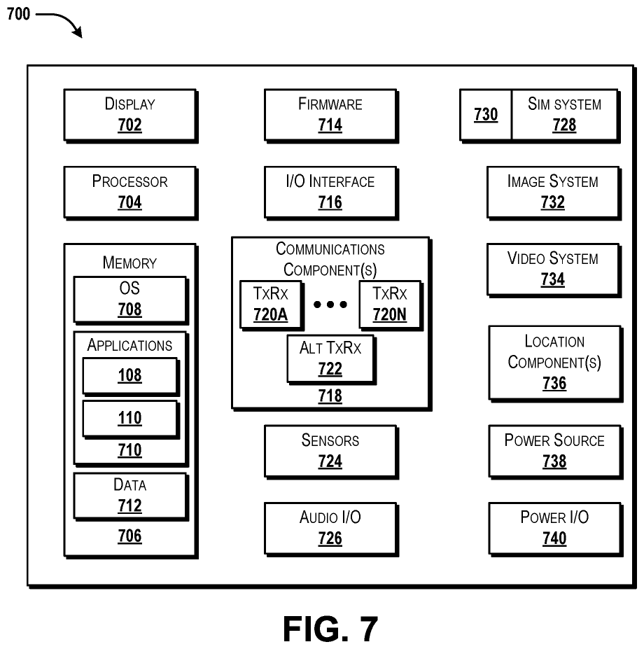

Turning now to FIG. 7, an illustrative mobile device 700 and components thereof will be described. In some embodiments, the user device 102 described above with reference to FIGS. 1-4 can be configured as and/or can have an architecture similar or identical to the mobile device 700 described herein in FIG. 7. It should be understood, however, that the user device 102 may or may not include the functionality described herein with reference to FIG. 7. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, the content 112, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in a memory 706, or the like. In some embodiments, the applications 710 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the playback application 108, the branching narrative content application 110, the branching narrative content service 116, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, the content 112, the input 114, the live manifest 122, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSDPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

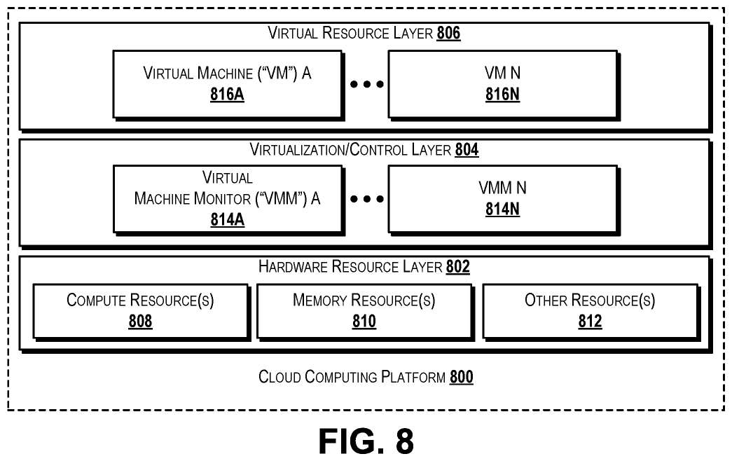

FIG. 8 illustrates an illustrative architecture for a cloud computing platform 800 that can be capable of executing the software components described herein for providing and using a branching narrative content service 116 and/or for interacting with the branching narrative content application 110 and/or the branching narrative content service 116. Thus, it can be appreciated that in some embodiments of the concepts and technologies disclosed herein, the cloud computing platform 800 illustrated in FIG. 8 can be used to provide the functionality described herein with respect to the user device 102, the server computer 118, and/or the content database 120.

The cloud computing platform 800 thus may be utilized to execute any aspects of the software components presented herein. Thus, according to various embodiments of the concepts and technologies disclosed herein, the playback application 108, the branching narrative content application 110, and/or the branching narrative content service 116 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the branching narrative content application 110 and the branching narrative content service 116 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that the an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, Calif.; one or more embodiment of the TEGRA brand family of SoCs, available from NVIDIA of Santa Clara, Calif.; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Tex.; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, Calif., and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the playback application 108, the branching narrative content application 110, the branching narrative content service 116, or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, content 112, the input 114, the live manifest 122, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for providing and using a branching narrative content service have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving a request for branching narrative content, the branching narrative content comprising a first segment, wherein the request for the branching narrative content is received from a user device,
generating a live manifest that comprises time metadata, a first content segment identifier that identifies a first content segment of the first segment, and a second content segment identifier that identifies a second content segment of the first segment,
providing the live manifest to the user device, wherein the user device obtains the first content segment using the first content segment identifier and the second content segment using the second content segment identifier, and wherein the user device obtains a selection of a branch while the first segment is being played by the user device,
receiving, from the user device, the selection of the branch,
generating an updated live manifest that comprises updated time metadata and a third content segment identifier that identifies a third content segment of a second segment that corresponds to the branch, and
providing the updated live manifest to the user device, wherein the user device obtains the third content segment using the third content segment identifier and plays the second segment at the user device.

2. The system of claim 1, wherein the first segment is played by the user device without prefetching the second segment, and wherein the second segment is obtained and played by the user device after the selection of the branch is obtained.

3. The system of claim 1, wherein the live manifest represents the branching narrative content over a sliding window of time associated with the branching narrative content, the sliding window of time corresponding to a fixed time duration of the branching narrative content.

4. The system of claim 1, wherein the updated live manifest comprises the first content segment identifier, the second content segment identifier, and the third content segment identifier.

5. The system of claim 1, wherein the updated live manifest comprises the second content segment identifier and the third content segment identifier, and wherein the updated live manifest does not include the first content segment identifier.

6. The system of claim 1, wherein the live manifest further includes overlay data that defines content of an overlay to be presented to obtain the selection of the branch, wherein the overlay is presented at a particular time before an end of the first segment, and wherein the particular time is identified in the time metadata.

7. The system of claim 1, wherein the user device obtains the first segment and the second segment from a content database that operates on a cloud data network.

8. A method comprising:
receiving, at a computer comprising a processor, a request for branching narrative content, the branching narrative content comprising a first segment, wherein the request for the branching narrative content is received from a user device;
generating, by the processor, a live manifest that comprises time metadata, a first content segment identifier that identifies a first content segment of the first segment, and a second content segment identifier that identifies a second content segment of the first segment;
providing, by the processor, the live manifest to the user device, wherein the user device obtains the first content segment using the first content segment identifier and the second content segment using the second content segment identifier, and wherein the user device obtains a selection of a branch while the first segment is being played by the user device;
receiving, by the processor and from the user device, the selection of the branch;
generating, by the processor, an updated live manifest that comprises updated time metadata and a third content segment identifier that identifies a third content segment of a second segment that corresponds to the branch; and
providing, by the processor, the updated live manifest to the user device, wherein the user device obtains the third content segment using the third content segment identifier and plays the second segment at the user device.

9. The method of claim 8, wherein the first segment is played by the user device without prefetching the second segment, and wherein the second segment is obtained and played by the user device after the selection of the branch is obtained.

10. The method of claim 8, wherein the live manifest represents the branching narrative content over a sliding window of time associated with the branching narrative content, the sliding window of time corresponding to a fixed time duration of the branching narrative content.

11. The method of claim 8, wherein the updated live manifest comprises the first content segment identifier, the second content segment identifier, and the third content segment identifier.

12. The method of claim 8, wherein the updated live manifest comprises the second content segment identifier and the third content segment identifier, and wherein the updated live manifest does not include the first content segment identifier.

13. The method of claim 8, wherein the live manifest further includes overlay data that defines content of an overlay to be presented to obtain the selection of the branch, wherein the overlay is presented at a particular time before an end of the first segment, and wherein the particular time is identified in the time metadata.

14. A computer storage medium having computer-executable instructions stored thereon that, when executed by a processor, cause the processor to perform operations comprising:
receiving a request for branching narrative content, the branching narrative content comprising a first segment, wherein the request for the branching narrative content is received from a user device;
generating a live manifest that comprises time metadata, a first content segment identifier that identifies a first content segment of the first segment, and a second content segment identifier that identifies a second content segment of the first segment;
providing the live manifest to the user device, wherein the user device obtains the first content segment using the first content segment identifier and the second content segment using the second content segment identifier, and wherein the user device obtains a selection of a branch while the first segment is being played by the user device;
receiving, from the user device, the selection of the branch;
generating an updated live manifest that comprises updated time metadata and a third content segment identifier that identifies a third content segment of a second segment that corresponds to the branch; and
providing the updated live manifest to the user device, wherein the user device obtains the third content segment using the third content segment identifier and plays the second segment at the user device.

15. The computer storage medium of claim 14, wherein the first segment is played by the user device without prefetching the second segment, and wherein the second segment is obtained and played by the user device after the selection of the branch is obtained.

16. The computer storage medium of claim 14, wherein the live manifest represents the branching narrative content over a sliding window of time associated with the branching narrative content, the sliding window of time corresponding to a fixed time duration of the branching narrative content.

17. The computer storage medium of claim 14, wherein the updated live manifest comprises the first content segment identifier, the second content segment identifier, and the third content segment identifier.

18. The computer storage medium of claim 14, wherein the updated live manifest comprises the second content segment identifier and the third content segment identifier, and wherein the updated live manifest does not include the first content segment identifier.

19. The computer storage medium of claim 14, wherein the live manifest further includes overlay data that defines content of an overlay to be presented to obtain the selection of the branch, wherein the overlay is presented at a particular time before an end of the first segment, and wherein the particular time is identified in the time metadata.

20. The computer storage medium of claim 14, wherein the user device obtains the first segment and the second segment from a content database that operates on a cloud data network.
